(19) United States
(12) Patent Application Publication
(10) Pub. No.: US 2018/0109130 A1
(43) Pub. Date: Apr. 19, 2018

(54) POWER DEVICE WITH MULTIPLE ELECTRIFYING MODES

(71) Applicant: Ta Hsing Electric Wire & Cable Co., Ltd., Taipei City (TW)

(72) Inventor: Chang-Hsin Lin, Taipei City (TW)

(21) Appl. No.: 15/408,427

(22) Filed: Jan. 18, 2017

(30) Foreign Application Priority Data
Oct. 19, 2016 (TW) 105133652

(51) Int. Cl. H02J 7/02; H02J 7/00; H01R 27/02; H01R 24/64

(52) U.S. Cl. CPC H02J 7/025; H02J 7/0052; H02J 7/0029; H01R 27/02; H01R 2107/00; H02J 2007/0062; H02J 2007/0059; H02J 2007/0039; H01R 24/64

(57) ABSTRACT

A power device with multiple electrifying modes is disclosed. The power device includes a casing, a power wire, a receptacle unit, a connecting port unit, a circuit unit and a wireless charging module. The power wire is coupled to an alternating current power source. The receptacle unit and the connecting port unit are disposed on the casing. The circuit unit is coupled to the power wire, the receptacle unit and the connecting port unit. The circuit unit rectifiers the alternating current power source to a direct current power source and provides the connecting port unit with the direct current power source. The circuit unit further provides the receptacle unit with the alternating current power source. The wireless charging module is coupled to the circuit unit. The circuit unit drives the wireless charging module to generate an electromagnetic field, so as to induct an electric potential for power supply.

### BACKGROUND OF THE INVENTION

### 1. Field of the Invention

The present invention relates to a power device, and more particularly, to a power device with multiple electrifying modes.

### 2. Description of the Prior Art

Generally speaking, a conventional extension cord is coupled to a wall socket, allowing home appliances to be coupled with the wall socket at desired locations, such as a desktop. Furthermore, the conventional extension cord can be equipped with multiple receptacles for multiple home appliances to be plugged with at the desired locations. However, the multiple receptacles on the conventional extension cord are in parallel connection with the wall socket. Thus, the multiple receptacles on the conventional extension cord are only able to provide the home appliances with alternating current for electrifying or charging. As a result, the conventional extension cord is incapable neither of providing current other than the alternating current nor satisfying electrifying and charging demands for various home appliances.

### SUMMARY OF THE INVENTION

The present invention provides a power device with multiple electrifying modes for solving above drawbacks.

According to an embodiment of the present invention, a power device with multiple electrifying modes includes a casing, a power wire, at least one receptacle unit, at least one connecting port unit, a circuit unit and a wireless charging module. The power wire is coupled to an alternating current power source. The at least one receptacle unit is disposed on the casing. The at least one connecting port unit is disposed on the casing. The circuit unit is coupled to the power wire, the at least one receptacle unit and the at least one connecting port unit. The circuit unit rectifiers the alternating current power source to a direct current power source and provides the at least one connecting port unit with the direct current power source. The circuit unit further provides the receptacle unit with the alternating current power source. The wireless charging module is coupled to the circuit unit. The circuit unit drives the wireless charging module to generate an electromagnetic field, so as to induct an electric potential for power supply.

According to another embodiment of the present invention, the wireless charging module is disposed inside the casing and includes a wireless charging circuit and a wireless charging transmitting means. The wireless charging circuit is electrically connected to the circuit unit. The wireless charging transmitting means is electrically connected to the wireless charging circuit.

According to another embodiment of the present invention, the casing is a substantially triangular structure. The casing has a first lateral portion, a second lateral portion and a third lateral portion. The first lateral portion, the second lateral portion and the third lateral portion are connected to one another. The power wire is outgoing from the firs lateral portion. The at least one connecting port unit is disposed on the second lateral portion, and the at least one receptacle unit is disposed on the third lateral portion.

According to another embodiment of the present invention, the casing further has a top portion. The first lateral portion, the second lateral portion and the third lateral portion are connected to one another, so as to form a peripheral portion. The top portion is connected to the peripheral portion, and the wireless charging transmitting means is attached to the top portion.

According to another embodiment of the present invention, a thickness of the top portion is smaller than a thickness of the peripheral portion.

According to another embodiment of the present invention, the casing is a substantially quadrilateral structure. The casing has a first lateral portion, a second lateral portion, a third lateral portion and a fourth lateral portion. The first lateral portion is opposite to the second lateral portion, and the third lateral portion is opposite to the fourth lateral portion. The third lateral portion connects an end of the first lateral portion and an end of the second lateral portion. The fourth lateral portion connects another end of the first lateral portion and another end of the second lateral portion. The power line is outgoing from the first lateral portion, and the at least one connecting port unit is disposed on the second lateral portion.

According to another embodiment of the present invention, the casing further has a top portion. The first lateral portion, the second lateral portion, the third lateral portion and the fourth lateral portion are connected to one another, so as to form a peripheral portion, and the top portion is connected to the peripheral portion.

According to another embodiment of the present invention, the at least one receptacle unit is disposed on at least one of the top portion, the third portion and the fourth lateral portion.

According to another embodiment of the present invention, the casing is a substantially cylindrical structure. The casing has a top portion and a peripheral portion. The peripheral portion is connected to the top portion, and the at least one receptacle unit and the at least one connecting port unit are disposed on the peripheral portion.

According to another embodiment of the present invention, the casing includes a housing and a base. The housing has a top portion and a peripheral portion. The peripheral portion is connected to the top portion, and the wireless charging transmitting means is attached to the top portion. The base is combined with the peripheral portion, so that the base and the housing cooperatively cover the circuit unit and the wireless charging module.

According to another embodiment of the present invention, the wireless charging module is disposed outside the casing and includes a wireless charging casing, a wireless charging circuit and a wireless charging transmitting means. The wireless charging casing is detachably installed on the casing. The wireless charging circuit is disposed inside the wireless charging casing. The wireless charging transmitting means is disposed inside the wireless charging casing and electrically connected to the wireless charging circuit.

According to another embodiment of the present invention, the power device further includes a first connector unit and a second connector unit. The first connector unit is disposed on the circuit unit. The second connector unit is disposed on the wireless charging circuit and capable of mating with the first connector unit.

According to another embodiment of the present invention, the first connector unit and the second connector unit are respectively a micro Universal Serial Bus connector (micro USB connector).

According to another embodiment of the present invention, the at least one connecting port unit is a Universal Serial Bus connector (USB connector).

According to another embodiment of the present invention, the power device further includes a protecting circuit unit and a reset unit. The protecting circuit unit is coupled to the circuit unit and the alternating current power source. The protecting circuit unit forms an open circuit when a threshold value is detected. The reset unit is coupled to the protecting circuit unit and for resetting the protecting circuit unit.

According to another embodiment of the present invention, the power device further includes a power switch unit coupled to the protecting circuit unit and the alternating current power source. The power switch unit is for electrically connecting the alternating current power source with the protecting circuit unit.

In summary, the circuit unit of the power device of the present invention is able to provide the receptacle unit with the alternating current power source, so that the receptacle unit is coupled to external home appliances in an alternating current manner. The circuit unit of the power device of the present invention is further able to rectifier the alternating current power source to the direct current power source and provide the connecting port unit with the direct current power source, so that the connecting port unit is couple to the external home appliances in a direct current manner. In addition, the power device of the present invention is equipped with the wireless charging module, so as to charge the external home appliances in a wireless manner. In conclusion, the power device of the present invention is able to provide the external electronic devices or home appliances with multiple electrifying modes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a power device according to a first embodiment of the present invention.

FIG. 2 is an exploded diagram of the power device according to the first embodiment of the present invention.

FIG. 3 is a functional block diagram of the power device according to the first embodiment of the present invention.

FIG. 4 is a diagram of the power device in a usage status according to the first embodiment of the present invention.

FIG. 5 is a diagram of a power device according to a second embodiment of the present invention.

FIG. 6 is a diagram of a power device according to a third embodiment of the present invention.

FIG. 7 is a diagram of a power device according to a fourth embodiment of the present invention.

### DETAILED DESCRIPTION

In the following detailed description of the embodiments, reference is made to the accompanying drawings which form a part hereof, and in which is shown by way of illustration specific embodiments in which the invention maybe practiced. In this regard, directional terminology, such as “top,” “bottom,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” and “installed” and variations thereof herein are used broadly and encompass direct and indirect connections and installations. Accordingly, the drawings and descriptions will be regarded as illustrative in nature and not as restrictive.

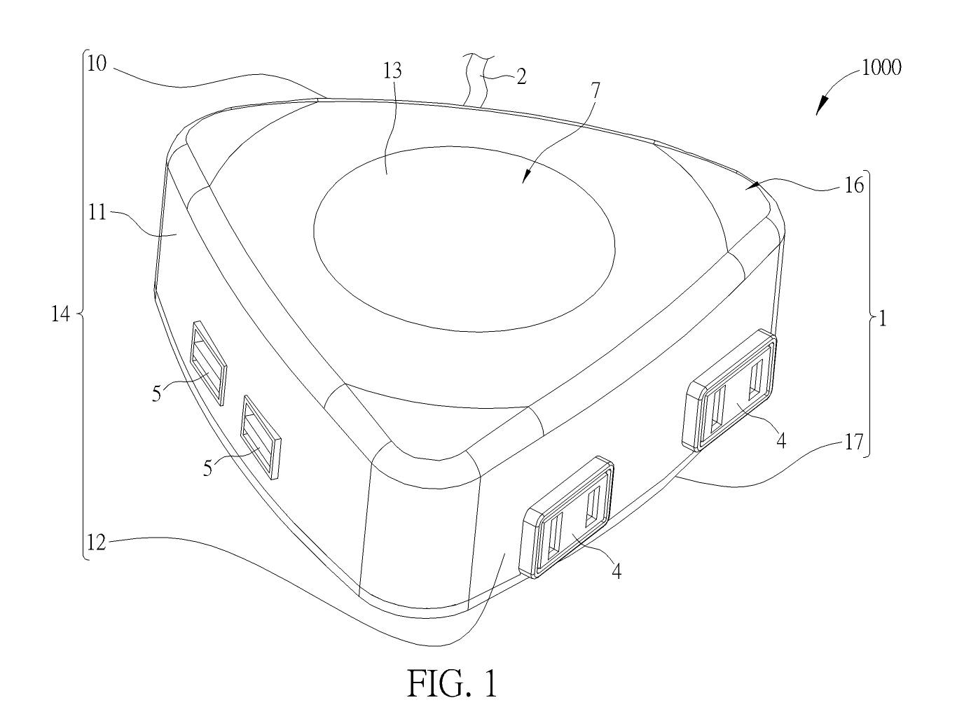

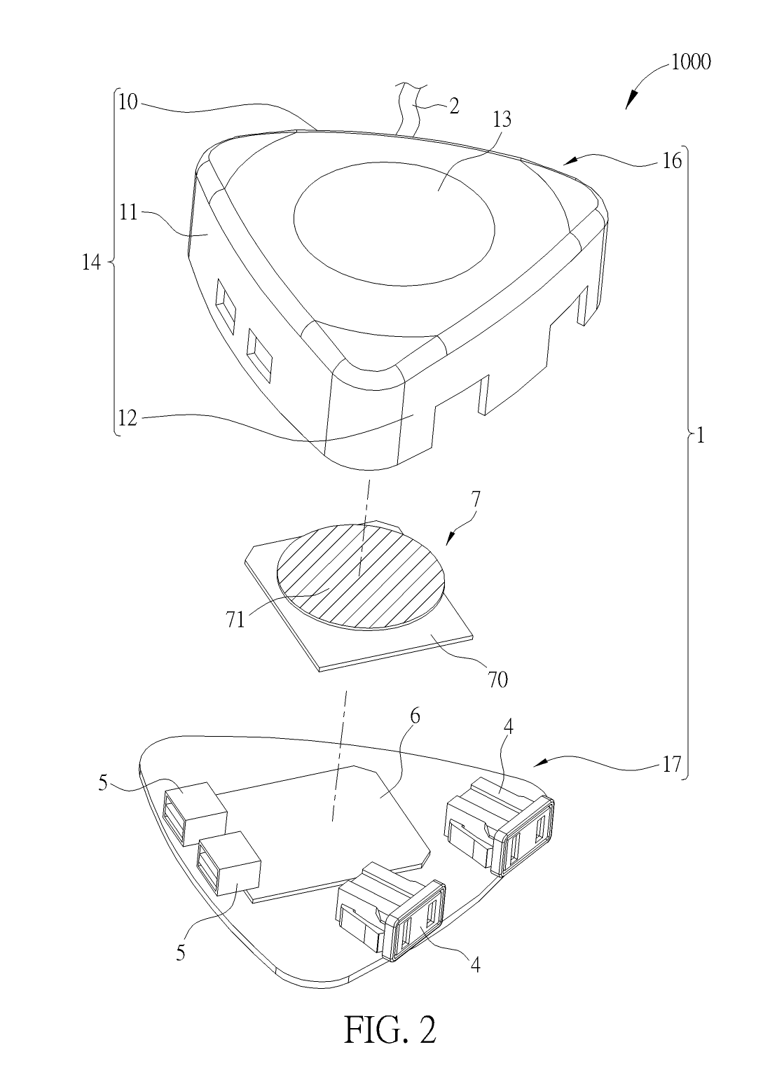

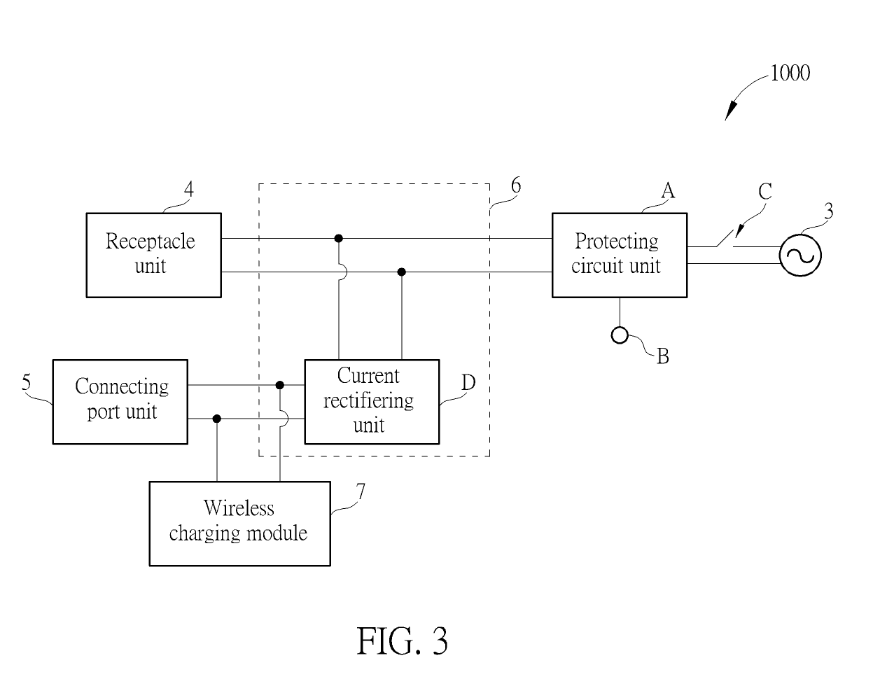

Please refer to FIG. 1 to FIG. 3. FIG. 1 is a diagram of a power device 1000 according to a first embodiment of the present invention. FIG. 2 is an exploded diagram of the power device 1000 according to the first embodiment of the present invention. FIG. 3 is a functional block diagram of the power device 1000 according to the first embodiment of the present invention. As shown in FIG. 3 to FIG. 3, the power device 1000 includes a casing 1, a power wire 2, two receptacle units 4, two connecting port units 5, a circuit unit 6 and a wireless charging module 7. The power wire 2 is used for coupling to an alternating current power source 3. In practical application, the power wire 2 can be plugged with a wall socket for coupling to the alternating current power source 3. The two receptacle units 4 and the two connecting port units 5 are respectively disposed on the casing 1. The circuit unit 6 is disposed in the casing 1 and coupled to the power wire 2, the two receptacle units 4 and the two connecting port units 5. In practical application, the receptacle units 4 and the connecting port units 5 can be electrically connected to the circuit unit 6 via wires, but the present invention is not limited thereto. For example, the receptacle units 4 and the connecting port units 5 can be welded to a copper first, and then electrically connected to the circuit unit 6 via the copper. As for which one of the above-mentioned designs is adopted, it depends on practical demands.

Furthermore, the wireless charging module 7 is disposed in the casing 1 and includes a wireless charging circuit 70 and a wireless charging transmitting means 71. The wireless charging circuit 70 is electrically connected to the circuit unit 6, and the wireless charging transmitting means 71 is electrically connected to the wireless charging circuit 70. Accordingly, the wireless charging module 7 is coupled to the circuit unit 6, so that the circuit unit 6 drives the wireless charging module 7 to generate an electromagnetic field, so as to induct an electric potential for power supply. In practical application, the wireless charging transmitting means 71 can be a wireless charging coil, but the present invention is not limited thereto. In addition, the power device 1000 further includes a protecting circuit unit A, a reset unit B, a power switch unit C and a current rectifiering unit D. The protecting circuit unit A is coupled to the circuit unit 6 and the alternating current power source 3. When a voltage or a current which is provided by the alternating current power source 3 to the circuit unit 6 reaches a threshold value, the protecting circuit unit A forms an open circuit for protecting the circuit unit 6. In practical application, the protecting circuit unit A can be an Over Voltage Protection (OVP) circuit or an Over Current Protection (OCP) circuit. Which one of the above-mentioned designs is adopted, it depends on practical demands.

Furthermore, the reset unit B is coupled to the protecting circuit unit A. When the protecting circuit unit A detects the threshold value and forms the open circuit, the reset unit B resets the protecting circuit unit A for initializing the protecting circuit unit A, so that the power device 1000 is normally operated. The power switch unit C is coupled to the protecting circuit unit A and the alternating current power source 3. The power switch unit C is for electrically connecting the alternating current power source 3 with the protecting circuit unit A. For example, when the power switch unit C is in a turn-on status, the power switch unit C electrically connects the alternating current power source 3 with the protecting circuit unit A, so that the alternating current power source 3 is coupled to the circuit unit 6 via the protecting circuit unit A. Accordingly, the power device 1000 is normally operated. On the other hand, when the power switch unit C is in a turn-off status, the power switch unit C disconnects the alternating current power source 3 from the protecting circuit unit A, so that the alternating current power source 3 is not coupled to the circuit unit 6 via the protecting circuit unit A. Accordingly, the power device 1000 is turned off. Furthermore, the current rectifiering unit D is coupled to the circuit unit 6, and electrically connected to the connecting port units 5 and the wireless charging circuit 70 of the wireless charging module 7. The current rectifiering unit D rectifiers the alternating current power source 3 into a direct current power source and provides the connecting port units 5 and the wireless charging module 7 with the direct current power source.

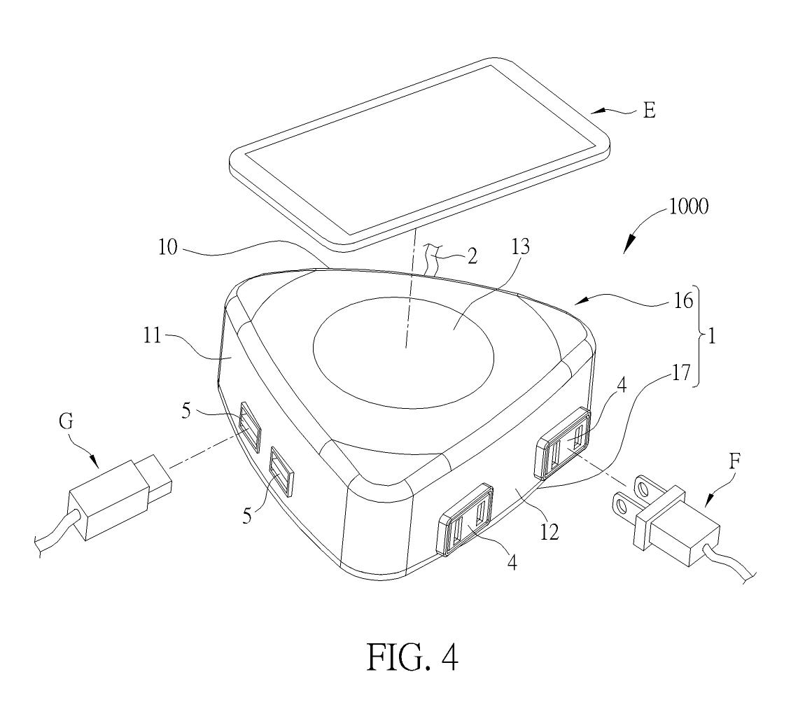

Descriptions for working principles of the power device 1000 is provides as follows. Please refer to FIG. 1 to FIG. 4. FIG. 4 is a diagram of the power device 1000 in a usage status according to the first embodiment of the present invention. As shown in FIG. 1 to FIG. 4, when the power device 1000 is utilized for charging an electronic device E (e.g., a cell phone) in a wireless manner, the power wire 2 is coupled to the alternating current power source 3. Meanwhile, the circuit unit 6 of the power device 1000 electrically connects the alternating current power source 3 with the wireless charging transmitting means 71 via the wireless charging circuit 70, so that the wireless charging transmitting means 71 is charged by the current rectifiering unit D for generating the time-varying electromagnetic field, so as to induce a charging current inside the electronic device E in a wireless manner. Meanwhile, a plug F is able to be further plugged with the receptacle units 4 of the power device 1000. Accordingly, the power device 1000 provides another electronic device (e.g., a desktop computer, a notebook computer) with the alternating current power source 3 via the receptacle units 4 and the plug F. Alternatively, a connector G is able to be further mated with the connecting port units 5 of the power device 1000. Accordingly, the power device 1000 rectifiers the alternating current power source 3 into the direct current power source by the current rectifiering unit D and provides the other electronic device (e.g., an external hardware drive, a mobile power supply and so on) with the direct current power source via the connecting port units 5 and the connector G.

It should be noticed that, in this embodiment, the current rectifiering unit D is only coupled with the circuit unit 6, i.e., there is no current rectifiering unit coupled with the wireless charging circuit 70. As a result, the size of the wireless charging circuit 70 can be reduced due to removal of the current rectifiering unit D, which results in decrease of size of the power device 1000.

In summary, the circuit unit 6 of the power device 1000 of the present invention is able to provide the receptacle units 4 with the alternating current power source 3, so that the receptacle units 4 are coupled to external home appliances in an alternating current manner. The circuit unit 6 of the power device 1000 of the present invention is further able to rectifier the alternating current power source 3 to the direct current power source via the current rectifiering unit D, and provides the connecting port units 5 with the direct current power source, so that the connecting port units 5 are couple to the external home appliances in a direct current manner. In addition, the power device 1000 of the present invention is equipped with the wireless charging module 7 which is coupled to the circuit unit 6, so as to charge the external home appliances in a wireless manner. In conclusion, the power device 1000 of the present invention is able to provide the external electronic devices or home appliances with multiple electrifying modes.

In this embodiment, the casing 1 is a substantially triangular structure. The casing 1 (i.e., the triangular structure) has a first lateral portion 10, a second lateral portion 11 and a third lateral portion 12. The first lateral portion 10, the second lateral portion 11 and the third lateral portion 12 are connected with one another. The power wire 2 is outgoing from the first lateral portion 10. The connecting port units 5 is disposed on the second lateral portion 11, and the receptacle units 4 is disposed on the third lateral portion 12. In addition, the casing 1 (i.e., the triangular structure) further has a top portion 13, wherein the first lateral portion 10, the second lateral portion 11 and the third lateral portion 12 are connected with one another to form a peripheral portion 14, and the top portion 13 is connected to the peripheral portion 14. The wireless charging transmitting means 71 of the wireless charging module 7 is attached to the top portion 13. The top portion 13 can be a platform which is for holding the electronic device E. Accordingly, when the electronic device E is placed on the top portion 13, the wireless charging transmitting means 71 is able to induce the electronic device E for charging the electronic device E in a wireless manner. It should be noticed that a thickness of the top portion 13 is smaller than a thickness of the peripheral portion 14. Practically, the thickness of the top portion 13 of the casing 1 is 1 mm, and the thickness of the peripheral portion 14 of the casing 1 is 2 mm. Accordingly, a distance between the wireless charging transmitting means 71 and the electronic device E can be reduced, so that the wireless charging transmitting means 71 is able to induce the electronic device E in a more effective way.

In this embodiment, the casing 1 can include a housing 16 and a base 17. The housing 16 has the top portion 13 and the peripheral portion 14. The base 17 is combined with the peripheral portion 14, so that the base 17 and the housing 16 cooperatively cover the circuit unit 6 and the wireless charging module 7. Practically, the housing 16 is able to be installed on the base 17 in a screwed manner, but the present invention is not limited thereto. For example, the housing 16 is able to be installed on the base 17 in a hooked manner as well. As for which one of the above-mentioned designs is adopted, it depends on practical demands. Furthermore, in this embodiment, the connecting port units 5 can be a Universal Serial Bus (USB) connector.

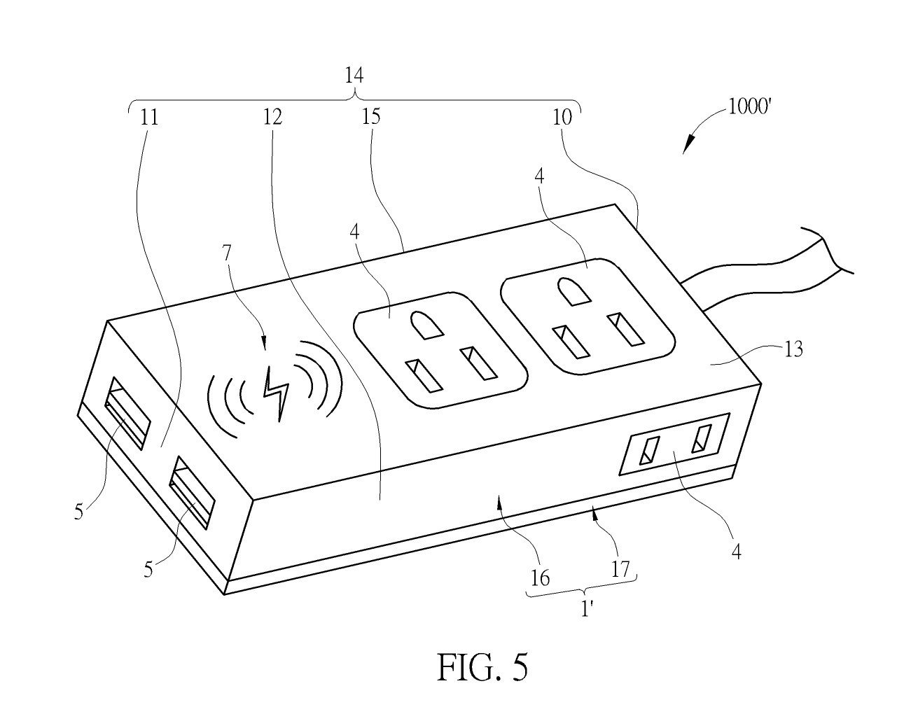

Please refer to FIG. 5. FIG. 5 is a diagram of a power device 1000′ according to a second embodiment of the present invention. As shown in FIG. 5, the major difference between the power device 1000′ and the aforesaid power device 1000 is that a casing 1′ of the power device 1000′ is substantially quadrilateral structure. The casing 1′ (i.e., the quadrilateral structure) has a first lateral portion 10, a second lateral portion 11, a third lateral portion 12 and a fourth lateral portion 15. The first lateral portion 10 is opposite to the second lateral portion 11, and the third lateral portion 12 is opposite to the fourth lateral portion 15. The third lateral portion 12 connects an end of the first lateral portion 10 with an end of the second lateral portion 11, and the fourth lateral portion 15 connects another end of the first lateral portion 10 with another end of the second lateral portion 11. The power wire 2 is outgoing from the first lateral portion 10. The connecting port units 5 is disposed on the second lateral portion 11. Furthermore, the casing 1′ (i.e., the quadrilateral structure) further has a top portion 13, and the first lateral portion 10, the second lateral portion 11, the third lateral portion 12 and the fourth lateral portion 15 forms a peripheral portion 14, wherein the top portion 13 is connected to the peripheral portion 14. Components with denoted in this embodiment identical to those in the aforesaid embodiment have identical structures and functions, and further description is omitted herein for simplicity.

It should be noticed that the power device 1000′ includes three receptacle units 4, wherein two receptacle units 4 with three holes are disposed on the top portion 13 of the casing 1′, and one the receptacle unit 4 with two holes is disposed on the third lateral portion 12 of the casing 1′. In another embodiment, the one receptacle unit 4 with two holes is able to be disposed on the fourth lateral portion 15 of the casing 1′ as well. In other words, structures that the receptacle units 4 are selectively disposed on at least one of the top portion 13, the third lateral portion 12 and the fourth lateral portion 15 of the casing 1′ are within the scope of the present invention.

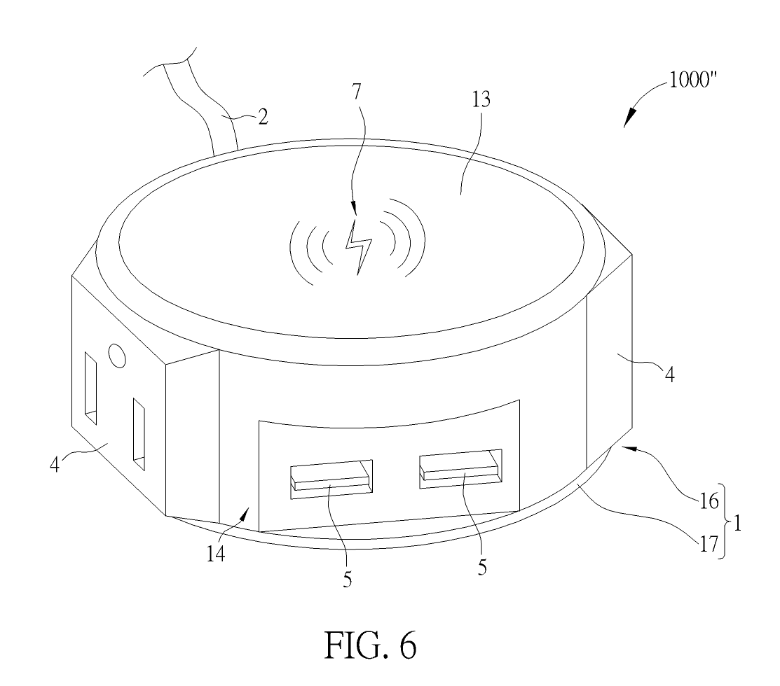

Please refer to FIG. 6. FIG. 6 is a diagram of a power device 1000″ according to a third embodiment of the present invention. As shown in FIG. 6, the major difference between the power device 1000″ and the aforesaid the power device 1000 is that a casing 1″ of the power device 1000″ is a substantially cylindrical structure. The casing 1″ (i.e., the cylindrical structure) has a top portion 13 and a peripheral portion 14. The peripheral portion 14 is connected to the top portion 13, and the receptacle units 4 and the connecting port units 5 are disposed on the peripheral portion 14. Components with denoted in this embodiment identical to those in the aforesaid embodiment have identical structures and functions, and further description is omitted herein for simplicity.

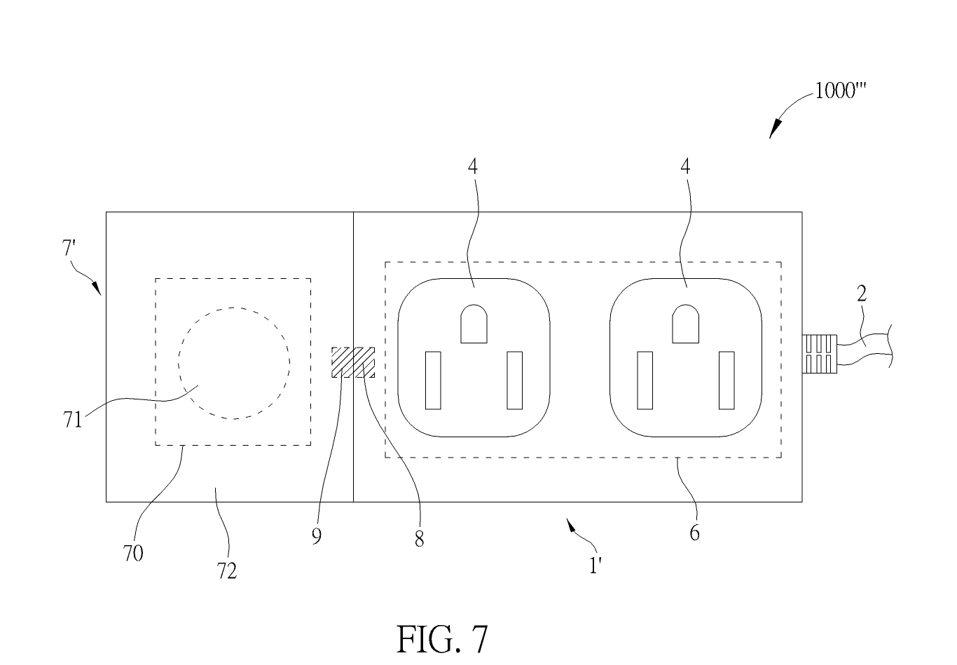

Please refer to FIG. 7. FIG. 7 is a diagram of a power device 1000″′ according to a fourth embodiment of the present invention. As shown in FIG. 7, the major difference between the power device 1000″′ and the aforesaid power device 1000′ is that a wireless charging module 7′ of the power device 1000″′ is disposed outside of the casing 1′ and includes a wireless charging circuit 70, a wireless charging transmitting means 71 and a wireless charging casing 72, wherein the wireless charging casing 72 is detachably installed on the casing 1′. The wireless charging circuit 70 and the wireless charging transmitting means 71 are disposed inside the wireless charging casing 72, and the wireless charging transmitting means 71 is electrically connected to the wireless charging circuit 70. In this embodiment, the power device 1000″′ further includes a first connector unit 8 and a second connector unit 9. The first connector unit 8 is disposed on the circuit unit 6, and the second connector unit 9 is disposed on the wireless charging circuit 70 and able to mated with the first connector unit 8. When the second connector unit 9 is mated with the first connector unit 8, the circuit unit 6 is coupled to the wireless charging circuit 70 and the wireless charging module 7 is combined with the casing 1. When the second connector unit 9 is unmated with the first connector unit 8, the wireless charging module 7 is detached from the casing 1. In this embodiment, the first connector unit 8 and the second connector unit 9 are respectively a micro Universal Serial Bus (micro USB) connector. Components with denoted in this embodiment identical to those in the aforesaid embodiment have identical structures and functions, and further description is omitted herein for simplicity.

Compared to the prior art, the circuit unit of the power device of the present invention is able to provide the receptacle unit with the alternating current power source, so that the receptacle unit is coupled to external home appliances in an alternating current manner. The circuit unit of the power device of the present invention is further able to rectifier the alternating current power source to the direct current power source and provide the connecting port unit with the direct current power source, so that the connecting port unit is couple to the external home appliances in a direct current manner. In addition, the power device of the present invention is equipped with the wireless charging module, so as to charge the external home appliances in a wireless manner. In conclusion, the power device of the present invention is able to provide the external electronic devices or home appliances with multiple electrifying modes.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A power device with multiple electrifying modes, comprising:
a casing;
a power wire coupled to an alternating current power source;
at least one receptacle unit disposed on the casing;
at least one connecting port unit disposed on the casing;
a circuit unit coupled to the power wire, the at least one receptacle unit and the at least one connecting port unit, the circuit unit rectifiering the alternating current power source to a direct current power source and providing the at least one connecting port unit with the direct current power source, the circuit unit further providing the receptacle unit with the alternating current power source; and
a wireless charging module coupled to the circuit unit, the circuit unit driving the wireless charging module to generate an electromagnetic field, so as to induct an electric potential for power supply.

2. The power device of claim 1, wherein the wireless charging module is disposed inside the casing and comprises:
a wireless charging circuit electrically connected to the circuit unit; and
a wireless charging transmitting means electrically connected to the wireless charging circuit.

3. The power device of claim 2, wherein the casing is a substantially triangular structure, the casing has a first lateral portion, a second lateral portion and a third lateral portion, the first lateral portion, the second lateral portion and the third lateral portion are connected to one another, the power wire is outgoing from the firs lateral portion, the at least one connecting port unit is disposed on the second lateral portion, and the at least one receptacle unit is disposed on the third lateral portion.

4. The power device of claim 3, wherein the casing further has a top portion, the first lateral portion, the second lateral portion and the third lateral portion are connected to one another, so as to form a peripheral portion, the top portion is connected to the peripheral portion, and the wireless charging transmitting means is attached to the top portion.

5. The power device of claim 4, wherein a thickness of the top portion is smaller than a thickness of the peripheral portion.

6. The power device of claim 2, wherein the casing is a substantially quadrilateral structure, the casing has a first lateral portion, a second lateral portion, a third lateral portion and a fourth lateral portion, the first lateral portion is opposite to the second lateral portion, the third lateral portion is opposite to the fourth lateral portion, the third lateral portion connects an end of the first lateral portion and an end of the second lateral portion, the fourth lateral portion connects another end of the first lateral portion and another end of the second lateral portion, the power line is outgoing from the first lateral portion, and the at least one connecting port unit is disposed on the second lateral portion.

7. The power device of claim 6, wherein the casing further has a top portion, the first lateral portion, the second lateral portion, the third lateral portion and the fourth lateral portion are connected to one another, so as to forma peripheral portion, the top portion is connected to the peripheral portion.

8. The power device of claim 7, wherein the at least one receptacle unit is disposed on at least one of the top portion, the third portion and the fourth lateral portion.

9. The power device of claim 2, wherein the casing is a substantially cylindrical structure, the casing has a top portion and a peripheral portion, the peripheral portion is connected to the top portion, and the at least one receptacle unit and the at least one connecting port unit are disposed on the peripheral portion.

10. The power device of claim 2, wherein the casing comprises:
a housing having a top portion and a peripheral portion, the peripheral portion being connected to the top portion, the wireless charging transmitting means being attached to the top portion; and
a base combined with the peripheral portion, so that the base and the housing cooperatively cover the circuit unit and the wireless charging module.

11. The power device of claim 1, wherein the wireless charging module is disposed outside the casing and comprises:
a wireless charging casing detachably installed on the casing;
a wireless charging circuit disposed inside the wireless charging casing; and
a wireless charging transmitting means disposed inside the wireless charging casing and electrically connected to the wireless charging circuit.

12. The power device of claim 11, further comprising:
a first connector unit disposed on the circuit unit; and
a second connector unit disposed on the wireless charging circuit and capable of mating with the first connector unit.

13. The power device of claim 12, wherein the first connector unit and the second connector unit are respectively a micro Universal Serial Bus connector.

14. The power device of claim 1, wherein the at least one connecting port unit is a Universal Serial Bus connector.

15. The power device of claim 1, further comprising:
a protecting circuit unit coupled to the circuit unit and the alternating current power source, the protecting circuit unit forming an open circuit when a threshold value is detected; and
a reset unit coupled to the protecting circuit unit and for resetting the protecting circuit unit.

16. The power device of claim 15, further comprising:
a power switch unit coupled to the protecting circuit unit and the alternating current power source, the power switch unit being for electrically connecting the alternating current power source with the protecting circuit unit.
